(19) United States
(12) Patent Application Publication
(10) Pub. No.: US 2022/0105866 A1
(43) Pub. Date: Apr. 7, 2022

(54) SYSTEM AND METHOD FOR ADJUSTING A LEAD TIME OF EXTERNAL AUDIBLE SIGNALS OF A VEHICLE TO ROAD USERS

(71) Applicant: Toyota Motor Engineering & Manufacturing North America, Inc., Plano, TX (US)

(72) Inventors: Benjamin P. AUSTIN, Saline, MI (US); Joshua E. DOMEYER, Madison, WI (US); John K. LENNEMAN, Okemos, MI (US)

(73) Assignee: TOYOTA MOTOR ENGINEERING & MANUFACTURING NORTH AMERICA, INC., Plano, TX (US)

(21) Appl. No.: 17/064,701

(22) Filed: Oct. 7, 2020

(51) Int. Cl. B60Q 5/00; G06K 9/00; B60W 40/105

(52) U.S. Cl. CPC B60Q 5/006; G06K 9/00302; B60W 2420/52; B60W 40/105; G06K 9/00791

(57) ABSTRACT

A system and a method for adjusting a lead time of external audible signals of a vehicle are provided. The system can include vehicle sensors, road user sensors, interface circuitry, processing circuitry, and memory. The road user sensors can detect one or more factors of one or more road users adjacent to the vehicle. The vehicle sensors can detect one or more conditions of the vehicle. The processing circuitry can determine a visual perception time of the one or more road users for a state change of the vehicle based on the one or more factors and the one or more conditions. The processing circuitry can adjust the lead time of the external audible signals based at least in part on the visual perception time.

### RELATED APPLICATIONS

This application is related to U.S. application Ser. No. 16/569,052, the entire contents of which are hereby incorporated by reference.

### FIELD

### Background

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

U.S. Ser. No. 10/497,255B1 to Friedland et al. describes communication systems in autonomous vehicles, and more particularly relates to systems and methods for autonomous vehicle communication with pedestrians. In particular, the invention includes that the pedestrian alerting system is configured to provide auditory guidance from the vehicle to a pedestrian.

### SUMMARY

According to an embodiment of the present disclosure, a system and a method for adjusting a lead time of external audible signals of a vehicle to road users are provided. The system can include vehicle sensors, road user sensors, camera modules, interface circuitry, processing circuitry, and memory. The first set of sensors can detect one or more factors of one or more road users adjacent to the vehicle. The second set of sensors can detect one or more conditions of the vehicle. The processing circuitry can determine a visual perception time of the one or more road users for a state change of the vehicle based on the one or more factors and the one or more conditions. The processing circuitry can adjust the lead time of the external audible signals based at least in part on the visual perception time.

In an example, the one or more factors can include one or more physical and emotional conditions of the one or more road users, or a visual fixation time of the one or more road users.

In an example, the visual fixation time of the one or more road users can include an amount of time which the one or more road users look at the vehicle.

In an example, the visual perception time can decrease if the visual fixation time increases.

In an example, the one or more physical and emotional conditions can include age, size, facial expression, or gestures of the one or more road users.

In an example, the one or more conditions can include a speed of the vehicle and a size of the vehicle.

In an example, the first set of sensors and the second set of sensors can include one or more camera modules, Lidar, radars, or ultrasonic sensors.

In an example, the state change of the vehicle can include acceleration, deceleration, yielding, and stopping.

In an example, the one or more road users can include pedestrians and cyclists.

In an example, the external audible signals can include a first signal for acceleration, a second signal for deceleration, a third signal for stopping, and a fourth signal for yielding.

According to an embodiment of the present disclosure, there is provided a non-transitory computer readable storage medium having instructions stored thereon that when executed by processing circuitry causes the processing circuitry to perform the method.

### BRIEF DESCRIPTION OF THE DRAWINGS

Various embodiments of this disclosure that are proposed as examples will be described in detail with reference to the following figures, wherein like numerals reference like elements, and wherein:

FIG. 1 is a schematic of an exemplary system 100 according to an embodiment of the disclosure;

FIGS. 2A-2B show examples of the vehicle sensors 110 or road user sensors 120, according to an embodiment of the disclosure;

FIG. 3 is a diagram showing one or more road users adjacent to one or more autonomous vehicles according to an embodiment of the disclosure;

FIG. 4 illustrates a roadway environment 400 in which embodiments of the invention can be deployed;

FIG. 5A is a graph illustrating a relationship between initial vehicle speed and the time it takes a road user to visually perceive a change in speed of the vehicle, in accordance with an illustrative embodiment of the invention;

FIG. 5B is a graph illustrating a relationship between road user visual fixation time and the time it takes a road user to perceive a change in speed of a vehicle, in accordance with an illustrative embodiment of the invention;

FIG. 6 illustrates an auditory lead time of an external audible signal of an autonomous vehicle on a timeline, in accordance with an illustrative embodiment of the invention; and

FIG. 7 is a flowchart outlining an exemplary process 600 according to an embodiment of the disclosure.

### DETAILED DESCRIPTION

A system can include camera modules, vehicle sensors, road user sensors, interface circuitry, processing circuitry, and memory. A first set of sensors can detect one or more factors of one or more road users adjacent to the vehicle. For example, the one or more can include one or more physical and emotional conditions of the one or more road users, or a measurement of gaze pattern of the one or more road users. The one or more physical and emotional conditions can include age, size, facial expression, or gestures of the one or more road users. The one or more road users include, but are not limited to, pedestrians, cyclists, people on scooters, and people in wheelchairs. The measurement of gaze pattern of the one or more road users can include an amount of time which the one or more road users look at the vehicle.

In an embodiment, a second set of sensors can detect one or more conditions of the vehicle. For example, the one or more conditions can include a speed of the vehicle and a size of the vehicle. Furthermore, the first set of sensors and the second set of sensors can include one or more camera modules, Lidar, radars, or ultrasonic sensors

In an embodiment, a processing circuitry can determine a visual perception time of the one or more road users for a state change of the vehicle based on the one or more factors and the one or more conditions. For example, the state change can include acceleration, deceleration, yielding, and stopping. If a vehicle accelerates while there is a road user adjacent to the vehicle, a state change of this vehicle may be visually perceived by the road user. Furthermore, the processing circuitry can determine a visual perception time of the road user based on the detected acceleration of this vehicle or the detected speed of this vehicle. In addition, the visual perception time can decrease if the visual fixation time increases.

In an embodiment, the processing circuitry can adjust the lead time of the external audible signals based on the visual perception time. The external audible signals can include a first signal for acceleration, a second signal for deceleration, a third signal for stopping, and a fourth signal for yielding. For example, based on the visual perception time of the road user determined by the processing circuitry, the processing circuitry may adjust an auditory signal of stopping the vehicle by the determined visual perception time. Furthermore, the road user may perceive the stopping of the vehicle at the same time when the road user receives the signal of stopping the vehicle.

In an embodiment, the perception time of the road users is a visual perception time in this invention. The external audible signal from an autonomous vehicle may need to match the visual perception time of the road users for the state change of the autonomous vehicle since the speed of sound is much slower than the speed of light in regard to the visual perception. For example, if road users are too close to an autonomous vehicle, the autonomous vehicle may try to communicate with the road users. The processing circuitry of the autonomous vehicle may decide to use the horn. If the honking from the autonomous vehicle to the road users is 0.1 s slower than the visual perception time of the road users for the state change of the autonomous vehicle, e.g., stopping, it may be necessary to adjust a lead time of the honking by 0.1 s so that the road users can hear the honking at the same time the road user visually perceives the state change of the autonomous vehicle.

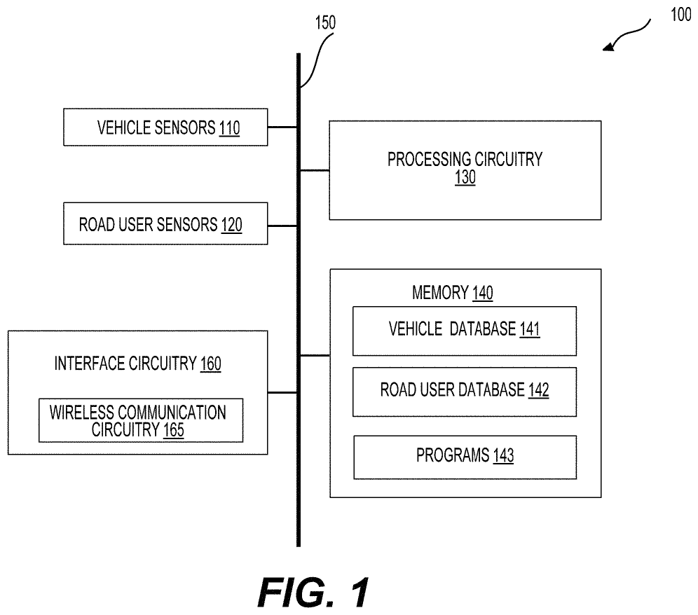

FIG. 1 is a schematic of an exemplary system 100 according to an embodiment of the disclosure. The system 100 can include vehicle sensors 110, road user sensors 120, processing circuitry 130, memory 140, and interface circuitry 160 that are coupled together, for example, using a bus 150. In an example, such as shown in FIG. 1, the system 100 is a part of a first vehicle 101. The first vehicle can be any suitable vehicle that can move, such as a car, a cart, a train, or the like. The first vehicle can be an autonomous vehicle. Alternatively, certain components (e.g., the vehicle sensors 110 and the road user sensors 120) of the system 100 can be located in the first vehicle 101 and certain components (e.g., processing circuitry 130) of the system 100 can be located remotely in a server, a cloud, or the like that can communicate with the first vehicle 101 wirelessly.

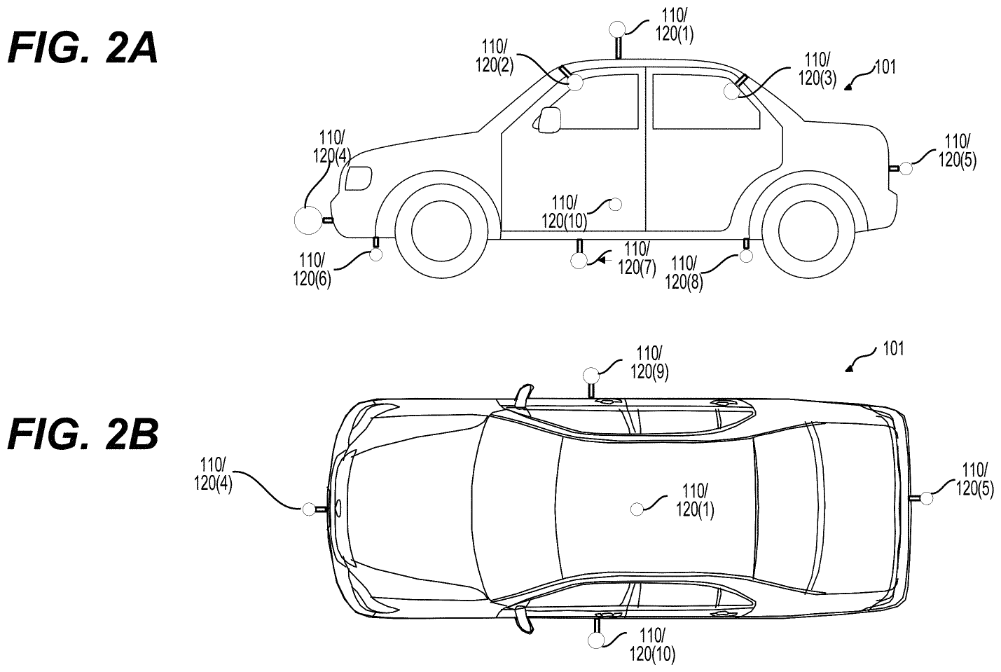

The vehicle sensors 110 and road user sensors 120 can be any suitable devices, e.g., camera modules, which can obtain images or videos. The vehicle sensors 110 and road user sensors 120 can capture different views around the first vehicle 101. In some embodiments, the first vehicle may be in a platoon. The vehicle sensors 110 and road user sensors 120 can capture images or videos associated with one or more factors of one or more road users adjacent to the first vehicle 101. The vehicle sensors 110 and road user sensors 120 can capture images and videos associated with the one or more road users adjacent to the first vehicle 101. The vehicle sensors 110 and road user sensors 120 can be fixed to the first vehicle 101. The vehicle sensors 110 and road user sensors 120 can be detachable, for example, the vehicle sensors 110 and road user sensors 120 can be attached to, removed from, and then reattached to the first vehicle 101. In some embodiments, the vehicle sensors 110 and road user sensors 120 can be positioned at any suitable locations of any vehicles in the platoon, e.g., the first vehicle 101 in FIG. 2. The vehicle sensors 110 and road user sensors 120 can be oriented toward any suitable directions in the first vehicle 101. In some embodiments, the vehicle sensors 110 and road user sensors 120 can also be oriented toward any suitable direction of vehicles in the platoon. Accordingly, the vehicle sensors 110 and road user sensors 120 can obtain images or videos to show different portions of the surrounding environment of the first vehicle 101. In addition, the vehicle sensors 110 and road user sensors 120 can obtain images or videos to show different portions of the surrounding environment of platoon. The vehicle sensors 110 and road user sensors 120 can obtain information and data from the images and videos that were taken by the vehicle sensors 110 and road user sensors 120. The information and data may include the one or more factors or conditions of the road users adjacent to the first vehicle. In some embodiments, the information and data may also include the one or more factors or conditions of the road users adjacent to the platoon.

In some embodiments, the different portions of the surrounding environment of the first vehicle 101 of the platoon can include a front portion that is in front of the first vehicle 101, a rear portion that is behind the first vehicle 101, a right portion that is to the right of the first vehicle 101, a left portion that is to the left of the first vehicle 101, a bottom portion that shows an under view of the first vehicle 101, a top portion that is above the first vehicle 101, and/or the like. Accordingly, a front view, a rear view, a left view, a right view, a bottom view, and a top view can show the front portion, the rear portion, the left portion, the right portion, the bottom portion, and the top portion of the surrounding environment, respectively. For example, the bottom view can show a tire, a pothole beneath the first vehicle 101, or the like. In another example, the vehicle sensors 110 and road user sensors 120, e.g., camera modules, on a right portion and a left portion can show the behaviors of the vehicles adjacent to the first vehicle 101. Different portions, such as the left portion and the bottom portion, can overlap. Additional views (e.g., a right-front view, a top-left view) can be obtained by adjusting an orientation of a camera module, by combining multiple camera views, and thus show corresponding portions of the surrounding environment. An orientation of the vehicle sensors 110 and the road user sensors 120, e.g., camera modules, can be adjusted such that the camera module can show different portions using different orientations.

Each of the vehicle sensors 110 and road user sensors 120, e.g., camera modules, can be configured to have one or more field of views (FOVs) of the surrounding environment, for example, by adjusting a focal length of the respective vehicle sensors 110 and road user sensors 120 or by including multiple cameras having different FOVs in the camera modules of the vehicle sensors 110 and the road user sensors 120. Accordingly, the first camera views can include multiple FOVs of the surrounding environment. The multiple FOVs can show the factors or conditions of the road users surrounding an autonomous vehicle, e.g., the first vehicle 101.

In general, the vehicle sensors 110 and road user sensors 120, e.g., camera modules, can include taking different views and/or different FOVs of the surrounding environment. In an example, the images can include the front view, the right-front view, the front bird-eye view (i.e., the front view with the bird-eye FOV), the normal left-front view (i.e., the left-front view with the normal FOV), and/or the like.

The vehicle sensors 110 and road user sensors 120 can be a vehicle speed sensor, a wheel speed sensor, a compass heading sensor, an elevation sensor, a LIDAR, a sonar, a GPS location sensor, or the combination thereof. For example, a vehicle speed sensor can provide a speed data of the first vehicle 101. In another example, the vehicle speed sensor can provide a speed data of the road users adjacent to the first vehicle 101. The GPS location sensor can provide one or more GPS coordinates on a map for the first vehicle 101. In an example, the GPS location sensor can provide location data for the road users adjacent to the first vehicle 101. Therefore, the data collected by vehicle sensors 110 and road user sensors 120 can be vehicle speed data, wheel speed data, compass heading data, elevation data, GPS location data, or the combination thereof.

The vehicle sensors 110 and road user sensors 120 can further be thermometers, humidity sensors, air quality sensors, or the combination thereof. Therefore, the data collected by the vehicle sensors 110 and the road user sensors 120 can further include external data such as temperature, humidity, air quality, or the combination thereof. In an example, the vehicle sensors 110 and the road user sensors 120 can further include the temperature of the vehicles adjacent to the first vehicle 101.

In some embodiments, the external data such as temperature, humidity, air quality, or the combination thereof affects the speed of the audible signals. For example, if the humidity is higher, the speed of sound is faster. When we calculate a lead time of the audible signals travelling in the air to the road users, a faster speed of the audible signals traveling to the road users will have a shorter lead time.

In some embodiments, a weather condition detected by vehicle sensors 110 and road user sensors 120 may be used to determine the lead time of the audible signals. For example, the speed of audible signals is faster on a rainy day than a sunny day, therefore, the lead time of the audible signals will be shorter when the audible signals travel on a rainy day. In another example, the sound level of the external audible signal may be increased if ambient sound is higher on a rainy day due to precipitation since the likelihood of the road user hearing the audible signals is lower. The sound level of the external audible signal may also be increased if ambient sound is higher in a city due to denser traffic and other mechanical noises since the likelihood of the road user hearing the audible signals is also lower.

In an embodiment, the data collected by the vehicle sensors 110 and the road user sensors 120 may be telemetry data. The telemetry data may include vehicle data and road user data. The vehicle data can be stored in vehicle database 142 in the memory 140 and the road user data can be stored in road user database 141 in the memory 140. The telemetry data collected by the vehicle sensors 110 and the road user sensors 120 can be derived from one or more vehicle sensors 110 and road user sensors 120, e.g., camera modules, affixed to the first vehicle 101. The telemetry data collected by the vehicle sensors 110 and the road user sensors 120, e.g., camera modules 110, can also be derived from the one or more camera modules or sensors taken by passengers in the first vehicle 101. The program 143 in the memory 140 may analyze the database from the data collected by the vehicle sensors 110 and the road user sensors 120. In addition, the first vehicle 101 may be in the platoon. Therefore, the telemetry data collected by the vehicle sensors 110 and the road user sensors 120 can also be derived from one or more vehicle sensors 110 and road user sensors 120, e.g., camera modules, affixed to the vehicles in the platoon.

FIGS. 2A-2B show examples of the vehicle sensors 110 (e.g., the vehicle sensors 110 (1)-(10)) or road user sensors 120 (e.g., the road user sensors 120(1)-(10)), according to an embodiment of the disclosure. For example, the vehicle sensor 110(1) is positioned on a top side of the first vehicle 101. The vehicle sensors 110(2)-(3) are positioned on a left side of the first vehicle 101 where the vehicle sensor 110(2) is near a front end of the first vehicle 101 and the vehicle sensor 110(3) is near a rear end of the first vehicle 101. The vehicle sensor 110(4) is positioned on the front end of the first vehicle 101 where the vehicle sensor 110(5) is positioned at the rear end of the first vehicle 101. The vehicle sensors 110(6)-(8) are positioned on a bottom side of the first vehicle 101. The vehicle sensors 110(9)-(10) are positioned on the left side and a right side of the first vehicle 101, respectively.

In an example, the road user sensor 120(1) is positioned on a top side of the first vehicle 101. The road user sensors 120(2)-(3) are positioned on a left side of the first vehicle 101 where the road user sensor 120(2) is near a front end of the first vehicle 101 and the road user sensor 120(3) is near a rear end of the first vehicle 101. The road user sensor 120(4) is positioned on the front end of the first vehicle 101 where the road user sensor 120(5) is positioned at the rear end of the first vehicle 101. The road user sensors 120(6)-(8) are positioned on a bottom side of the first vehicle 101. The road user sensors 120(9)-(10) are positioned on the left side and a right side of the first vehicle 101, respectively.

In an example, the vehicle sensors 110 and the road user sensors 120 can be positioned together. The vehicle sensor 110(1) and the road user sensor 120(1) are positioned on a top side of the first vehicle 101. The vehicle sensors 110(2)-(3) and the road user sensors 120(2)-(3) are positioned on a left side of the first vehicle 101 where the vehicle sensor 110(2) and the road user sensor 120(2) are near a front end of the first vehicle 101 and the vehicle sensor 110(3) and the road user sensor 120(3) are near a rear end of the first vehicle 101. The vehicle sensor 110(4) and the road user sensor 120(4) are positioned on the front end of the first vehicle 101 where the vehicle sensor 110(5) and the road user sensor 120(5) are positioned at the rear end of the first vehicle 101. The vehicle sensors 110(6)-(8) and the road user sensors 120(6)-(8) are positioned on a bottom side of the first vehicle 101. The vehicle sensors 110(9)-(10) and the road user sensors 120(9)-(10) are positioned on the left side and a right side of the first vehicle 101, respectively.

In an example, the vehicle sensor 110(4) is oriented such that the vehicle sensor 110(4) can obtain images or videos of the front portion of the surrounding environment. For example, the front potion of the surrounding environment may include the vehicles or road users adjacent to the first vehicle 101. In addition, the road user sensor 120(4) may or may not be oriented such that the road user sensor 120(4) can detect more information such as current weather condition, temperature, sound from other vehicles or road users adjacent to the first vehicle 101, or a combination thereof.

The descriptions related to the vehicle sensor 110(4) and the road user sensor 120(4) can be suitably adapted to other camera modules or sensors. For example, the vehicle sensor 110(10) is oriented such that the vehicle sensor 110(10) can obtain images or videos of the left portion of the surrounding environment or the vehicles or road users adjacent to the first vehicle 101. In addition, the road user sensor 120(10) may or may not be oriented such that the road user sensor 120(4) can detect more information such as current weather condition, temperature, sound from other vehicles or road users adjacent to the first vehicle 101, or a combination thereof. Therefore, the one or more factors or conditions of the road users may be captured by the images or videos.

In some embodiments, the surrounding environment of the first vehicle 101 can include road conditions, lane markers, road signs, traffic signs, objects including, for example, vehicles, pedestrians, obstacles, on or close to the roads, and the like. The surrounding environment of the first vehicle 101 may include the one or more factors or conditions of the road users adjacent to the first vehicle 101. The one or more factors or conditions may include one or more physical and emotional conditions of the one or more road users, or visual fixation time of the one or more road users. The visual fixation time of the one or more road users may be an amount of time which the one or more road users continuously look at or fixate on the vehicle.

In some embodiments, the one or more road users may include, but are not limited to, pedestrians, cyclists, people on scooters, and people in wheel chairs. The one or more road users may also include, but are not limited to, drivers of vehicles, people on mopeds, or motorists. For example, the road user adjacent to an autonomous vehicle may be a pedestrian walking on a sidewalk. In another example, the road user adjacent to the autonomous vehicle may be a person riding a scooter in a lane adjacent to the autonomous vehicle.

In some embodiments, the one or more physical conditions of the one or more road users may include age of the road users, e.g., age of the pedestrians or drivers. The one or more physical conditions may also include body type, e.g., size of the pedestrians, or size of the motorists. The one or more physical conditions may also include gender, e.g., gender of the pedestrians. The one or more physical conditions may include activities that the road user is currently performing, e.g., the road user may be currently running on a sidewalk. For example, the road user currently running on a sidewalk may not identify the state change of the autonomous vehicle easily. Therefore, when the lead time of the external audible signal is calculated, the lead time may need to be increased in consideration of the time of identification of the autonomous vehicle and the time required to perceive the state change. The identification time is a time at which the road users begin to look at the autonomous vehicles. The visual perception time is a time required for the road users to perceive the state change of the autonomous vehicles after the road users begin to look at the autonomous vehicles.

In some embodiments, although the identification time is used to calculate the lead time of the external audible signal, in some instances, the auditory signal must be sent out regardless of identification time. For example, if the road user is at a large distance from the autonomous vehicle, the amount of time required for the external auditory signal to reach the road user may be greater than the estimated amount of time required for the road user to perceive the state change of the autonomous vehicle. In order to avoid a situation where the external auditory signal reaches the road user after the road user perceives the state change of the autonomous vehicle, the external auditory signal may start before the road user begins to look at the autonomous vehicle. Thus, the auditory signal must be sent out regardless of the identification time.

In some embodiments, the one or more emotional conditions of the road users may include facial expressions or gestures, e.g., sadness or excitement. For example, the road user sensors may capture that the pedestrian is laughing. In another example, the road user currently laughing may not identify the state change of the autonomous vehicle easily because of the distraction. Similarly, when the lead time of the external audible signal is calculated, the lead time may need to be increased in consideration of the time of identification of the autonomous vehicle and the time required to perceive the state change.

In some embodiments, the one or more conditions of the road users adjacent to the autonomous vehicle may include the conditions of the drivers of the vehicles, scooters, or motorcycles adjacent to the autonomous vehicle. The conditions may include changes in vehicle speed, changes in lane position, driver head orientation, driver head movement, and location of hands of the drivers on a steering wheel of the one or more vehicles adjacent to the autonomous vehicle. For example, vehicles close to the autonomous vehicle may change lanes because the autonomous vehicle is approaching to the lane that the vehicles is located. In another example, when the vehicle adjacent to the autonomous vehicle is changing lanes, the driver of the vehicles may not identify the state change of the autonomous vehicle easily because of distraction. Therefore, the lead time of the road user, e.g., the vehicle adjacent to the autonomous vehicle, will be longer in order to match the visual perception time. As described above, an identification time is a time at which the driver begins to look at the autonomous vehicles.

In some embodiments, the road user sensors 120 can capture traffic signs and/or road signs (e.g., for re-routing during an event, such as a marathon), potential hazardous objects such as a pothole, accident debris, a roadkill, and/or the like.

In an embodiment, an event occurs near the road users adjacent to the autonomous vehicle. The road user sensor 120 can be used to show certain portions of the surrounding environment of the road users. For example, the event is a marathon and roads are rerouted. If the processing circuitry knows that the marathon event is happening nearby the road users adjacent to the autonomous vehicle, the road users may have a higher chance to look at the event instead of focusing on the state change of the autonomous vehicle. Therefore, an identification time of the road users for the state change of the speed of the autonomous vehicle may be longer due to the distraction from a marathon event. In some embodiments, the events can also include a recurring event such as a school drop-off and/or pick-up in a school zone, a bus drop-off and/or pick-up at a bus stop along a bus route, or a railroad crossing.

In an embodiment, the system 100 can also include camera modules or sensors, e.g., an internal camera inside the first vehicle 101, configured to obtain images of the face of the driver or the passenger, for example, for face recognition, weight sensors configured to determine the weight information of the driver or the passengers and/or the like. For example, the weight sensors can provide weight information of the current autonomous vehicle weight when passengers are in the autonomous vehicle, so a response time of the autonomous vehicle, e.g., a braking time of the autonomous vehicle, may be calculated and predicted and factored in to calculate the lead time of the external audible signals to the passengers.

In an embodiment, the vehicle sensors 110 can include any suitable devices that can detect vehicle characteristics, e.g., a vehicle type, a vehicle weight information, a vehicle manufacturer, a driving history of the autonomous vehicle, or the like. The vehicle sensors 110 can be detachable from the autonomous vehicle, e.g., first vehicle 101. The vehicle sensors 110 can be attached to the autonomous vehicle, e.g., first vehicle 101. In some embodiments, the vehicle sensors 110 may be attached to the passengers, e.g., a cell phone of a passenger. The vehicle sensors 110 can be detachable from the passenger in the autonomous vehicle, e.g., first vehicle 101. The vehicle sensors 110 can be attached to the passengers in the autonomous vehicle, e.g., first vehicle 101.

In an embodiment, the road user sensors 120 can include any suitable devices that can detect user characteristics, e.g., a face of the road user adjacent to the autonomous vehicle. The face information may be used to determine the emotional states of the road users and the emotional states may affect a visual perception time or an identification time of the road users. The road user sensors 120 can be detachable from the autonomous vehicle, e.g., first vehicle 101. The road user sensors 120 can be attached to the autonomous vehicle, e.g., first vehicle 101. In some embodiments, the road user sensors 120 may be attached to the road users, e.g., a cell phone on a pedestrian. The road user sensors 120 can be detachable from the road users adjacent to the autonomous vehicle. The road user sensors 120 can be attached to the road users adjacent to the autonomous vehicle.

The interface circuitry 160 can be configured to communicate with any suitable device or the user of the autonomous vehicle, e.g., first vehicle 101, using any suitable devices and/or communication technologies, such as wired, wireless, fiber optic communication technologies, and any suitable combination thereof. The interface circuitry 160 can include wireless communication circuitry 165 that is configured to receive and transmit data wirelessly from servers (e.g., a dedicated server, a cloud including multiple servers), vehicles (e.g., using vehicle-to-vehicle (V2V) communication), infrastructures (e.g., using vehicle-to-infrastructure (V2I) communication), one or more third-parties (e.g., a municipality), map data services (e.g., Google Maps, Waze, Apple Maps), and/or the like. In an example, the wireless communication circuitry 165 can communicate with mobile devices including a mobile phone via any suitable wireless technologies such as IEEE 802.15.1 or Bluetooth. In an example, the wireless communication circuitry 165 can use wireless technologies, such as IEEE 802.15.1 or Bluetooth, IEEE 802.11 or Wi-Fi, mobile network technologies including such as global system for mobile communication (GSM), universal mobile telecommunications system (UMTS), long-term evolution (LTE), fifth generation mobile network technology (5G) including ultra-reliable and low latency communication (URLLC), and the like.

The interface circuitry 160 can include any suitable individual device or any suitable integration of multiple devices such as touch screens, keyboards, keypads, a mouse, joysticks, microphones, universal series bus (USB) interfaces, optical disk drives, display devices, audio devices, e.g., speakers, and the like. The interface circuitry may include a display device. The display device can be configured to display images/videos captured by one of the vehicle sensors 110 or road user sensors 120.

The interface circuitry 160 can also include a controller that converts data into electrical signals and sends the electrical signals to the processing circuitry 130. The interface circuitry 160 can also include a controller that converts electrical signals from the processing circuitry 130 to the data, such as visual signals including text messages used by a display device, audio signals used by a speaker, and the like. For example, the interface circuitry 160 can be configured to output an image on an interactive screen and to receive data generated by a stylus interacting with the interactive screen.

The interface circuitry 160 can be configured to output data, such as vehicle data and road user data from the vehicle sensors 110 and the road user sensors 120 determined by the processing circuitry 130, to the autonomous vehicle, e.g., first vehicle 101, and the like.

The interface circuitry 160 can be configured to receive data, such as the vehicle data and the road user data described above. The vehicle data can include or indicate driving scenarios and/or vehicle characteristics for the vehicle by the respective vehicle sensors 110 such as times, locations, vehicle types, events, and/or like. For example, as described above, the events information provided by the vehicle data can be used to determine the identification time of the road users for the state change of the autonomous vehicle if the events are also adjacent to road users. As described earlier, the identification time is a time at which the road users begin to look at the autonomous vehicle.

In some embodiments, the vehicle data can include or indicate which lane that the autonomous vehicle is currently driving, head of the autonomous vehicle, or movement of the head of the driver or passengers in the autonomous vehicle.

In some embodiments, the road user data can indicate or include road information of certain events (e.g., an accident, a criminal event, a school event, a construction, a celebration, a sport event) for the road users. For example, the road information of certain events can occur in or in close proximity (e.g., a distance between the road user and the event is within a certain distance threshold) of the road user. As described above, these events may also affect the identification time of the road users for the state change of the autonomous vehicle if the events are also adjacent to road users. Therefore, the time of arrival of the audible signal to the road users may need to be adjusted to match the visual perception time of the road users due to the road information. As described earlier, the identification time is a time at which the road users begin to look at the autonomous vehicle. The visual perception time is a time required for the road users to perceive the state change of the autonomous vehicles after the road users begin to look at the autonomous vehicles. Although the identification time is used to calculate the lead time of the external audible signal, in some instances, the auditory signal must be sent out regardless of identification time.

The interface circuitry 160 can be configured to receive routing data for routing the autonomous vehicle, e.g., the first vehicle 101. In an example, the interface circuitry 160 can receive positioning information from various satellite-based positioning systems such as a global positioning system (GPS), and determine a position of the first vehicle 101. In some examples, the position can be a physical address, the latitude and longitude coordinates of a geographic coordinate system used by satellite-based positioning systems such as a GPS, and the like.

In some embodiments, the vehicle data history of the autonomous vehicle may include interactions with road users in certain time of a day or in some specific streets or roads. For example, the vehicle data history may include history that the road users may see the autonomous vehicle more clearly during the day than at night. In another example, the vehicle data history may include history that some pedestrians may not see the autonomous vehicle easily because one or more buildings block the sight of the pedestrians on First Avenue of the city. Therefore, the identification time of the road users for the state change of the autonomous vehicle may be longer. As described earlier, the identification time is a time at which the road users begin to look at the autonomous vehicle. Although the identification time is used to calculate the lead time of the external audible signal, in some instances, the auditory signal must be sent out regardless of identification time.

The processing circuitry 130 can be configured to determine a visual perception time of the road users from the vehicle data from the vehicle database 141 and the road user data from the road user database 142. For example, if the processing circuitry 130 receives information that the vehicle type of the autonomous vehicle may be a compact vehicle and the pedestrian may be an elderly person, the processing circuitry 130 may determine that a visual perception time of the elderly person may be longer than teenagers since the elderly person may have a higher chance of visual impairments which may affect detection of the state change of the autonomous vehicle. In addition, because the autonomous vehicle is a compact vehicle, the processing circuitry 130 may also determine that the visual perception time of road users for the state change of a compact vehicle may need to be longer since it may be more difficult to detect the movement of the compact vehicle due to the size of the compact vehicle, e.g., more difficult to detect the stopping or the yielding of the compact vehicle.

The processing circuitry 130 can obtain the vehicle data or road user data directly or can extract the vehicle data or road user data from images, videos, or the like. In an example, the processing circuitry 130 receives images from the autonomous vehicle, e.g., the first vehicle 101. The images can show a portion of a surrounding environment of the first vehicle. The processing circuitry 130 can extract road user information based on the images. For example, the processing circuitry 130 can extract the road user information such as pedestrians, motorists, or cyclists based on the received images.

In an example shown in FIG. 1, the processing circuitry 130 is part of the autonomous vehicle, e.g., the first vehicle 101. In an example, the processing circuitry 130 can be implemented in a server, a cloud, or the like, that is remote from the first vehicle 101. The server, the cloud, or the like can communicate wirelessly with the first vehicle 101 regarding the reconstruction, the vehicle data, and the road user data, or the like.

The memory 140 is configured to store vehicle data in the vehicle database 141. The memory 140 is also configured to store road user data in the road user database 142, and programs 143. In an embodiment, information (e.g., data in the vehicle database 141, the road user database 142) in the memory 140 can be modified or updated by the processing circuitry 130. The modified information can also be uploaded to a cloud services platform that can provide on-demand delivery of computing power, database storage, and IT resources or shared with other vehicles, for example, using the wireless communication circuitry 165 via V2I and V2V communications, respectively.

The memory 140 can be a non-volatile storage medium. In another embodiment, the memory 140 includes both non-volatile and volatile storage media. In one embodiment, a portion of the memory 140 can be integrated into the processing circuitry 130. The memory 140 can be located remotely and communicate with the processing circuitry 130 via a wireless communication standard using the wireless communication circuitry 165.

In an embodiment, in the FIG. 1, for example, the components are coupled together by a bus architecture including a bus 150. Other suitable interconnection techniques can also be used.

One or more components of the interface circuitry 160, the processing circuitry 130, and the memory 140 can be made by discrete devices or integrated devices. The circuits for one or more of the interface circuitry 160, the processing circuitry 130, and the memory 140 can be made by discrete circuits, one or more integrated circuits, application-specific integrated circuits (ASICs), and the like. The processing circuitry 130 can also include one or more central processing units (CPUs), one or more graphic processing units (GPUs), dedicated hardware or processors to implement neural networks, and the like.

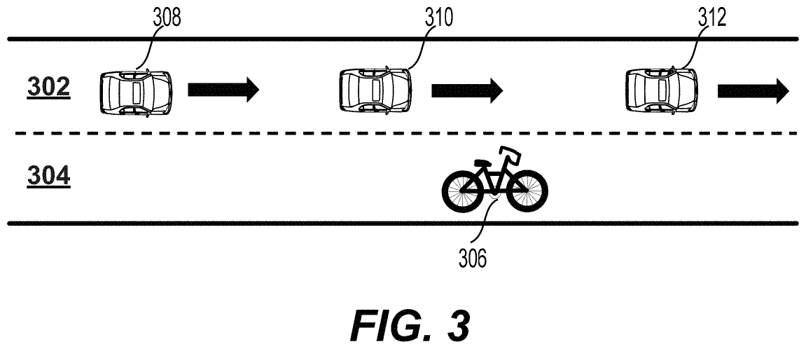

FIG. 3 is a diagram showing one or more road users adjacent to one or more autonomous vehicles according to an embodiment of the disclosure.

In an embodiment, the vehicle sensors, road user sensors, and camera modules in the autonomous vehicles 308, 310, and 312 in the lane 302 may capture images or videos of the cyclist 306 in the lane 304 and collect data, e.g., one or more factors of the cyclist 306. For example, the one or more factors of the cyclist 306 may include age of the cyclist and type of the bicycle. In addition, the vehicle sensors, road user sensors, and camera modules in the autonomous vehicles 308, 310, and 312 may detect one or more conditions of the autonomous vehicles 308, 310, and 312. For example, the one or more conditions of the autonomous vehicles may include size of the autonomous vehicles and model of the autonomous vehicles.

In an embodiment, the processing circuitry may analyze the images or videos of the cyclist 306, one or more factors of the cyclists 306, and one or more conditions of the vehicles 308, 310, and 312, to determine a visual perception time of the cyclist 306. The one or more conditions may include weather conditions, e.g., fog, humidity, or air quality. For example, the perception time of the cyclist 306 in a foggy day may be longer than in a sunny day. After the visual perception time is determined, the processing circuitry may adjust a lead time of the external audible signal based on the visual perception time. For example, if the processing circuitry determines that the external audible signal will reach the road users adjacent to the autonomous vehicle 0.5 s after those road users visually perceive the state change of the autonomous vehicle, the auditory signal lead time will be adjusted by 0.5 s. Therefore, the time of arrival of the external audible signal to the road users will match the visual perception time of the road users for the state change of the autonomous vehicle. In addition, the adjustment of the auditory signal lead time can further protect the safety of the road users adjacent to the autonomous vehicle since the external audible signal reaching the road users can communicate with the road users about the state change of the autonomous vehicle. The risk of accident between the road users and the autonomous vehicle can be reduced.

In an embodiment, the vehicle sensors, road user sensors, and camera modules in the autonomous vehicles 308, 310, and 312 may capture images or videos of the cyclist 306 in the lane 304 and collect data, e.g., one or more factors of the cyclist 306. For example, the one or more factors of the cyclist 306 may include age of the cyclist, and type of the bicycle. In addition, the vehicle sensors, road user sensors, and camera modules in the autonomous vehicles 308, 310, and 312 may detect one or more conditions of the autonomous vehicles 308, 310, and 312. For example, the one or more conditions of the autonomous vehicles may include size of the autonomous vehicles and model of the autonomous vehicles.

In an embodiment, the processing circuitry may analyze the images or videos of the cyclist 306, one or more factors of the cyclist 306, and one or more conditions of the vehicles 308, 310, and 312, to determine a visual perception time of the cyclist 306. For example, a younger cyclist may have a shorter visual perception time than an older cyclist. After the visual perception time is determined, the processing circuitry may adjust a lead time of the external audible signal based on the visual perception time. For example, if the processing circuitry determines that the external audible signal will reach the cyclist 306 adjacent to the autonomous vehicle 0.5 s after those road users visually perceive the state change of the autonomous vehicle, the lead time will be adjusted by 0.5 s. Therefore, the time of arrival of the external audible signal will match the visual perception time of the cyclist 306 for the state change of the autonomous vehicle. In addition, the adjustment of the lead time can further protect the safety of the cyclist 306 adjacent to the autonomous vehicle since the external audible signal reaching the cyclist 306 can communicate with the cyclist 306 about the state change of the autonomous vehicle. The risk of collision between the cyclist 306 and the autonomous vehicle can be reduced.

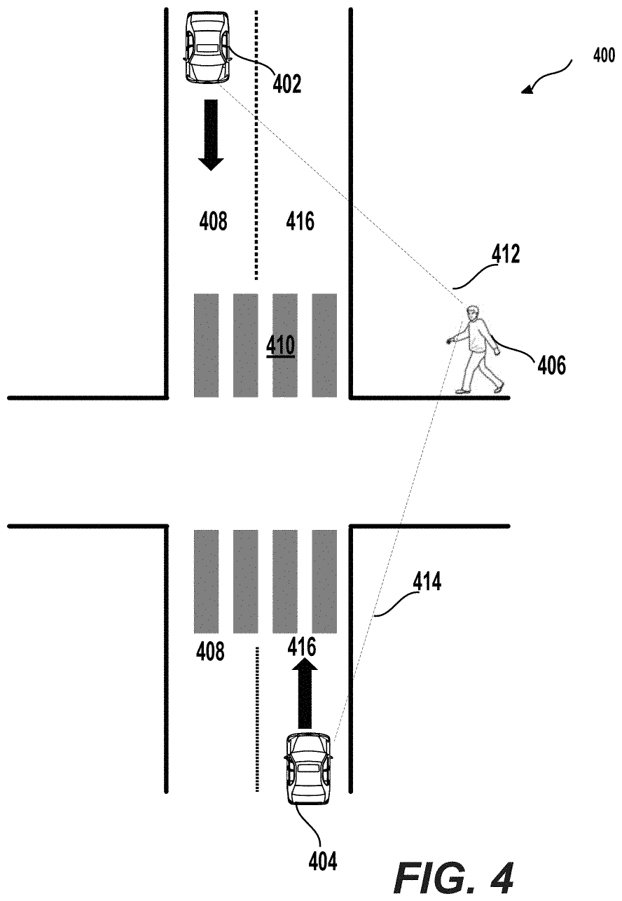

FIG. 4 illustrates a roadway environment 400 in which embodiments of the invention can be deployed. In the example of FIG. 4, vehicle 402 is traveling along roadway 408. A road user 406, e.g., a pedestrian, is about to cross roadway 408 in crosswalk 410 as vehicle 402 approaches. Road user sensors 120 can detect the presence of road user 406. Depending on the embodiment, road user sensors 120 can measure and capture a gaze pattern 412 of road user 406. For example, road user sensors 120 can determine an amount of time which road user 406 is looking at vehicle 402 immediately prior to a change in speed of vehicle 402.

In some embodiments, the processing circuitry may use the data collected from the road user sensors 120 to determine or estimate the age of road user 406, estimate the emotional state of road user 406, or a combination of both. In some embodiments, the processing circuitry can determine the speed at which road user 406 is moving, if road user 406 is in motion. Using input data such as the initial speed of vehicle 402 immediately prior to commencement of a change in speed, the measured gaze patterns of road user 406, the speed at which road user 406 is moving, the determined or estimated age of road user 406 and a pedestrian distraction metric, e.g., an estimated emotional state of road user 406, the processing circuitry can determine a lead time, relative to the commencement of a change in speed of vehicle 402, that coincides with the estimated moment at which road user 406 will visually perceive the change in speed of vehicle 101.

In some embodiments, the processing circuitry takes only a subset of these various factors into account in computing the lead time. For example, some embodiments emphasize the initial speed of vehicle 402 and the measured gaze patterns of road user 406 in computing the lead time. An external audible device, e.g., a horn, will output a signal in accordance with the lead time to notify road user 406 of the change in speed of vehicle 402. The lead time may also depend on the current traveling speed of sound in the air affected by the current weather conditions as described above, e.g., a foggy day or a sunny day. The lead time of the external audible device may try to match the visual perception time of the road user 406.

In some embodiments, in another example of FIG. 4, vehicle 404 is traveling along roadway 416. The road user 406, e.g., a pedestrian, is about to cross roadway 416 in crosswalk 410 as vehicle 404 approaches. As discussed above, road user sensors 120 detect the presence of road user 406. In this embodiment, road user sensors 120 can measure and analyze a gaze pattern 414 of road user 406. For example, road user sensors 120 can determine an amount of time which road user 406 is looking at vehicle 404 immediately prior to a change in speed of vehicle 404. In addition, the amount of time which the road user 406 is looking at vehicle 404 can be used to determine a visual perception time of the road user 406 for the change in speed of vehicle 404. Furthermore, a lead time of the external audible signal can further be determined based on the current traveling speed of sound and the estimated visual perception time of the road user 406.

In some embodiments, as described above, the processing circuitry may use the data collected from the road user sensors 120 to determine or estimate the age of road user 406, estimate the pedestrian distraction metric, e.g., the emotional state of road user 406, or a combination of both. As described above, the identification time of the road user 406 may be affected by the age of the road user 406 or the emotional state of the road user 406. In addition, the lead time of the external audible signal will be adjusted by the identification time of the road user 406. For example, an elderly person may have a longer identification time for the change in speed of an autonomous vehicle due to eye problems. Therefore, a lead time may need to be adjusted further by the identification time. As described earlier, the identification time is a time at which the road user begins to look at the autonomous vehicle. Although the identification time is used to calculate the lead time of the external audible signal, in some instances, the auditory signal must be sent out regardless of identification time.

In some embodiments, the processing circuitry can determine the speed at which road user 406 is moving, if road user 406 is in motion. Using input data such as the initial speed of vehicle 402 immediately prior to commencement of a change in speed, the measured gaze patterns of road user 406, the speed at which road user 406 is moving, the determined or estimated age of road user 406 and the pedestrian distraction metric, e.g., the estimated emotional state, of road user 406, the processing circuitry can determine another lead time, relative to the commencement of a change in speed of vehicle 402, that coincides with the estimated moment at which road user 406 will visually perceive the change in speed of vehicle 404.

In some embodiments, the processing circuitry takes only a subset of these various factors into account in computing the lead time. For example, some embodiments emphasize the initial speed of vehicle 404 and the measured gaze patterns of road user 406 in computing the lead time. An external audible device, e.g., a horn, will output a signal in accordance with the lead time to notify road user 406 of the change in speed of vehicle 404. In some embodiments, the lead time associated with the vehicle 404 may be different from the lead time associated with the vehicle 402 due to the different driving direction of the vehicles 402 and 404.

In an embodiment, the speed of sound may be affected by the weather conditions, e.g., a foggy day or a sunny day. For example, the speed of sound may travel quicker in the foggy day, therefore, the lead time of an external audible signal may be shorter since the external audible signal reaches the road user faster than in a sunny day. In another example, the lead time may be increased if ambient sound is higher on a rainy day or in cities since the likelihood of the road user hearing the audible signals is lower.

The roadway environment 400 depicted in FIG. 4 is only one example of an environment in which embodiments of the invention can be deployed. Embodiments can be deployed in a variety of other situations in which vehicles and road users interact. Examples include, without limitation, crosswalks at intersections, crosswalks at locations other than intersections (the scenario depicted in FIG. 4), and parking lots.

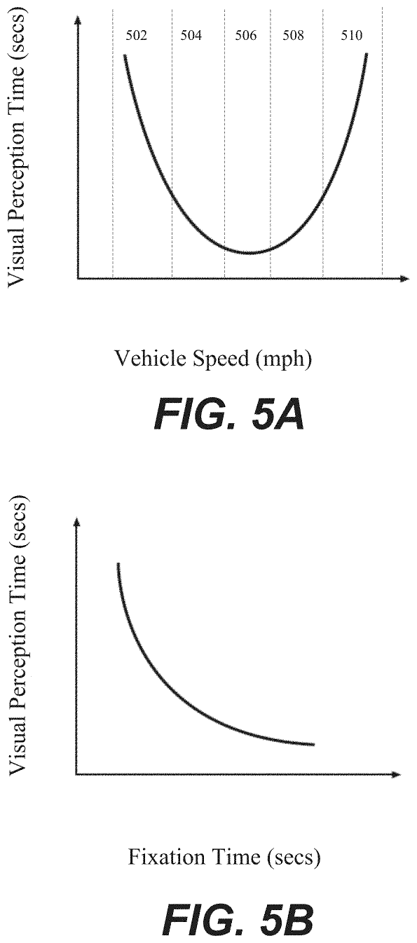

FIG. 5A is a graph illustrating a relationship between initial vehicle speed and the time it takes a road user to visually perceive a change in speed of the vehicle, in accordance with an illustrative embodiment of the invention. As indicated in FIG. 5A, road users require more time to perceive a change in speed when the initial speed of the vehicle is extremely fast or extremely slow. In between those extremes, the visual perception time is shorter in accordance with a predictable relationship. A processing circuitry 130 can determine the initial speed of vehicle 101 from the vehicle's own on-board speed measurement apparatus (e.g., a speedometer) or from a speed measurement that is transmitted to vehicle 101 from an infrastructure sensor device, depending on the particular embodiment.

In an embodiment, the graph is divided by five zones, e.g., 502, 504, 506, 508, and 510. The lines between each zone represent cut off points to adjust the lead time of the external audible signal. In the zone 506, the graph shows that the visual perception time has a low dependence to the change in the speed of vehicles. In the zones 504 and 508, the graph shows that the visual perception time has a medium dependency to the change in the speed of vehicles. In the zones 502 and 510, the graph shows that the visual perception time has a high dependency to the change in the speed of vehicles. Therefore, if a vehicle changes its speed in the zone 506, the visual perception time may not need to be adjusted as much as 502, 504, 508, and 510, and especially for 502 and 510. In addition, if the vehicle changes its speed in the zones 504 and 508, the perception may need to be slightly adjusted. However, if the vehicle changes its speed in the zones 502 and 510, the visual perception time may need to be adjusted drastically. FIG. 5B is a graph illustrating a relationship between road user visual-fixation time and the time it takes a road user to visually perceive a change in speed of a vehicle, in accordance with an illustrative embodiment of the invention. As indicated in FIG. 5B, a road user's visual perception time decreases as gaze or fixation time increases. As discussed above, road user sensors 120 can detect gaze patterns of road users, and the processing circuitry 130 can use that gaze-pattern data in estimating the lead time.

In some embodiments, initial vehicle speed and gaze-pattern data can be combined in different ways to compute the lead time, depending on the embodiment. For example, a range of possible visual perception times is first determined based on the initial vehicle speed, and the lead time can then be “fine tuned” within that range based on other factors such as road user's measured gaze patterns. For example, if a road user is determined to have been gazing at a vehicle 101 before vehicle 101 changes speed, e.g., accelerates or decelerates, the lead time can be shortened within the range of visual perception times initially determined from the initial vehicle speed. Depending on the embodiment, additional factors beyond initial vehicle speed and measured road user's gaze patterns can also be taken into account in determining the lead time. Those other factors include, without limitation, the speed at which a road user is moving, the age of a road user, and the emotional state of the road user. As mentioned above, examples of other factors that processing circuitry 130 can take into account in determining the lead time are the known or estimated age of a detected road user and the estimated emotional state of the road user. As discussed above, the road user sensors 120 detect age-related data, emotional-state-related data, or both for detected road users, and that information can be fed to the processing circuitry 130 for use in determining the lead time. As mentioned above in connection with analyzing road user's gaze patterns, considerations such as age and emotional state can be viewed as another way to fine tune the computation of lead time within a possible range of visual perception times corresponding to the initial speed of vehicle 101. For example, advanced age or a detected depressed mood could be the basis for increasing the estimated lead time within the expected range. Likewise, youth or a detected cheerful mood could be the basis for decreasing the lead time within the expected range. The above examples are only a few of the possible implementations but not limited.

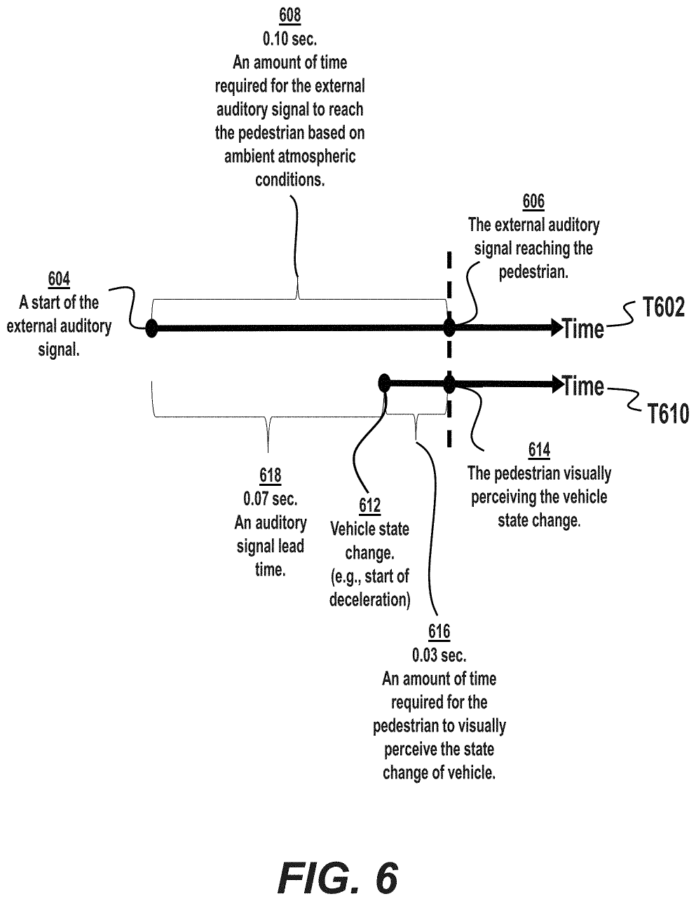

FIG. 6 illustrates an auditory lead time of an external audible signal of an autonomous vehicle on a timeline.

In FIG. 6, two timelines are shown, e.g., T602 and T610. On the timeline T602, a beginning point 604 is a start of an external auditory signal and an end point 606 is the external auditory signal reaching a road user, e.g., a pedestrian. An amount of time 608 required for the external auditory signal to reach the pedestrian based on ambient atmospheric conditions is 0.10 s, which is calculated from 604 to 606 on the timeline T602.

On the timeline T610, a beginning point 612 is a vehicle state change, e.g., a start of deceleration, etc. An end point 614 on the timeline T610 is the pedestrian visually perceiving the vehicle state change. An amount of time 616 required for the pedestrian to visually perceive the state change of vehicle is 0.03 s, which is calculated from 612 to 614. However, since the external auditory signal needs to reach the pedestrian at the same time when the pedestrian visually perceives the vehicle state change, an auditory signal lead time will need to be applied to the external auditory signal. Thus, the auditory signal lead time 618 is a difference between the amount of time required for the external auditory signal to reach the pedestrian and the amount of time required for the pedestrian to visually perceive the state change of vehicle, which is 0.07 s, as illustrated in FIG. 6.

The start of the external auditory signal 604 and the end point of the external auditory signal reaching the pedestrian 606 can be suitably modified. The beginning point of vehicle state change 612 and the end point of the pedestrian visually perceiving the vehicle state change 614 can be suitably modified. Thus, the auditory signal lead time can be longer or shorter.

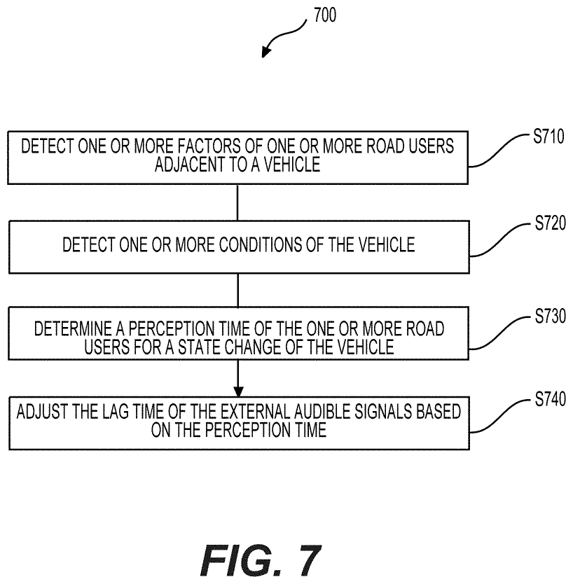

FIG. 7 is a flowchart outlining an exemplary process 700 according to an embodiment of the disclosure. In an example, the process 700 can be implemented using the system 100 described in FIG. 1. In an embodiment, the process 700 can be used to adjust a lead time of external audible signals based on a visual perception time of road users. For purposes of brevity, descriptions are given for the first vehicle 101, and the descriptions can be suitably adapted to any suitable vehicle. As described above, the autonomous vehicle, e.g., first vehicle 101, can include the vehicle sensors 110 and the road user sensors 120 configured to have vehicle data and road user data. The process 700 starts at S710 and proceeds to S740.

At S710, one or more factors of one or more road users adjacent to a vehicle, e.g., the first vehicle 101, can be detected, for example, via the road user sensors 120 in FIG. 1, as described above with reference to the embodiment. The data related to the one or more factors of the one or more road users can be from the road user sensors 120.

In an embodiment, data, e.g., images or videos, from the road user sensors are received by the interface circuitry 160, and the data are determined by the processing circuitry 130 from the received data, images, or videos. In some embodiments, the road user sensors 120 may also detect the surrounding environment of the vehicle including traffic, road condition, or the like.

The one or more factors of the road users may include the one or more physical and emotional conditions of the one or more road users, or a gaze pattern of the one or more road users. For example, the factors may include age, size, facial expression, or gestures of the road user, which can further indicate that the road user is a teenager, or the like.

At S720, one or more conditions of the vehicle are detected. For example, the one or more conditions of the vehicle may include size of the vehicle, manufacturer of the vehicle, or the like. For example, the vehicle may detect that the vehicle is a medium size vehicle or the color is white, or the like.

At S730, the processing circuitry 130 can determine a visual perception time of the one or more road users for a state change of the vehicle. For example, if the road user is an elderly person, the visual perception time for the elderly person may be longer than a teenager.

At S740, the processing circuitry 130 can adjust the lead time of the external audible signal based on the visual perception time. For example, as described earlier in FIG. 6, if the visual perception time determined by the processing circuitry in the step S730 is 0.03 s and the time for the external audible signal to reach the road user is 0.1 s, the processing circuitry may adjust the lead time, e.g., 0.07 s, of the external audible signal, e.g., honking, by 0.07 s, so that the road user may receive the external audible signal at the same time when the road user visually perceives the state change of the autonomous vehicle.

Different vehicles and different road users can have different vehicle data and different road user data available in the respective vehicles and respective road users. The process 600 can be adapted by different vehicle type, different vehicle condition, and different road users. For example, the different road users may have different visual perception time.

The process 700 can be suitably modified. Steps can be added, omitted, and/or combined. An order of implementing steps in the process 700 can be adapted. In an example, the order of the steps S710 and S720 may be switched.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method of adjusting a lead time of external audible signals of a vehicle, comprising:
detecting, by a first set of sensors, one or more factors of one or more road users adjacent to the vehicle;
detecting, by a second set of sensors, one or more conditions of the vehicle;
determining, using processing circuitry, a perception time of the one or more road users for a state change of the vehicle based on the one or more factors and the one or more conditions; and
adjusting the lead time of the external audible signals based at least in part on the perception time.

2. The method of claim 1, wherein the one or more factors include one or more physical and emotional conditions of the one or more road users, or a fixation time of the one or more road users.

3. The method of claim 2, wherein the fixation time of the one or more road users includes an amount of time which the one or more road users look at the vehicle.

4. The method of claim 3, wherein the perception time is a visual perception time, the visual perception time decreasing as the fixation time increasing.

5. The method of claim 2, wherein the one or more physical and emotional conditions include age, size, facial expression, or gestures of the one or more road users.

6. The method of claim 1, wherein the one or more conditions include a speed of the vehicle and a size of the vehicle.

7. The method of claim 1, wherein the first set of sensors and the second set of sensors include one or more camera modules, Lidar, radars, or ultrasonic sensors.

8. The method of claim 1, wherein the state change includes acceleration, deceleration, yielding, and stopping.

9. The method of claim 1, wherein the one or more road users include pedestrians and cyclists.

10. The method of claim 1, wherein the external audible signals include a first signal for acceleration, a second signal for deceleration, a third signal for stopping, and a fourth signal for yielding.

11. A system for adjusting a lead time of external audible signals of a vehicle, comprising:
a database server including processing circuitry configured to:
detect, by a first set of sensors, one or more factors of one or more road users adjacent to the vehicle;
detect, by a second set of sensors, one or more behaviors of the vehicle;
determine, using processing circuitry, a perception time of the one or more road users for a state change of the vehicle based on the one or more factors and the one or more behaviors; and
adjust the lead time of the external audible signals based at least in part on the perception time.

12. The system of claim 11, wherein the one or more factors include one or more physical and emotional conditions of the one or more road users, or a fixation time of the one or more road users.

13. The system of claim 12, wherein the fixation time of the one or more road users includes an amount of time which the one or more road users look at the vehicle.

14. The system of claim 13, wherein the perception time is a visual perception time, the visual perception time decreasing as the fixation time increasing.

15. The system of claim 12, wherein the one or more physical and emotional conditions include age, size, facial expression, or gestures of the one or more road users.

16. The system of claim 11, wherein the one or more conditions include a speed of the vehicle and a size of the vehicle.

17. The system of claim 11, wherein the first set of sensors and the second set of sensors include one or more camera modules, Lidar, radars, or ultrasonic sensors.

18. The system of claim 11, wherein the state change includes acceleration, deceleration, yielding, and stopping.

19. The system of claim 11, wherein the external audible signals include a first signal for acceleration, a second signal for deceleration, a third signal for stopping, and a fourth signal for yielding.

20. A non-transitory computer readable storage medium having instructions stored thereon that when executed by processing circuitry causes the processing circuitry to perform a method, the method comprising:
detecting, by a first set of sensors, one or more factors of one or more road users adjacent to the vehicle;
detecting, by a second set of sensors, one or more behaviors of the vehicle;
determining, using processing circuitry, a perception time of the one or more road users for a state change of the vehicle based on the one or more factors and the one or more behaviors; and
adjusting the lead time of the external audible signals based at least in part on the perception time.
